(19) United States
(12) Patent Application Publication
(10) Pub. No.: US 2026/0264228 A1
(43) Pub. Date: Sep. 10, 2026

(54) GRIPPING OR CLAMPING DEVICE FOR GRIPPING OR CLAMPING OBJECTS IN DIFFERENT OPERATING MODES, AND METHOD THEREFOR

(71) Applicant: SCHUNK SE & Co. KG Spanntechnik Greiftechnik Automatisierungstechnik, Lauffen am Neckar (DE)

(72) Inventors: Sebastian Neitzel, Heilbronn (DE); Denis Carpenco, Lauffen am Neckar (DE); Steffen Mittendorff, Heilbronn (DE)

(21) Appl. No.: 19/126,053

(22) PCT Filed: Nov. 2, 2023
(86) PCT No.: PCT/EP2023/080509

§ 371 Date: Apr. 30, 2025

(30) Foreign Application Priority Data
Nov. 2, 2022 (DE) 10 2022 128 993.1

(51) Int. Cl. B25J 9/16; B25J 13/08; B25J 15/02

(52) U.S. Cl. CPC B25J 9/1612; B25J 13/083; B25J 15/0253

(57) ABSTRACT

A gripping or clamping device is provided for gripping or clamping items, comprising at least one main jaw that is movable relative to another main jaw, a drive mechanism configured to actuate the movable jaw, and a control unit. The control unit includes a controller for generating control signals to actuate the drive, a memory for storing commands and characteristic variables, and a communications interface for receiving predefinable gripping parameters. The memory stores commands for at least two different operating modes, and the controller processes these commands to generate corresponding control signals. The operating mode is selected based on at least one of the received gripping parameters and at least one of the stored characteristic variables, enabling adaptive and flexible operation of the device based on contextual inputs.

### FIELD

The present invention relates to a gripping or clamping device for gripping or clamping items, with at least one and preferably two main jaws which can be moved towards one another and away from one another, and to a method for operating such a gripping or clamping device.

### BACKGROUND

From DE 10 013 022 A1 a gripping or clamping device is known in which two main jaws are provided which can be moved towards one another and away from one another, wherein the main jaws are coupled in motion to a working piston via a gearbox, namely a key head gearbox, and a piston rod. The working piston borders two piston chambers; depending on the pressure on one or the other piston chamber, the main jaws are moved towards one another or away from one another.

EP 1 905 549 A1 discloses a gripping device with a rotary drive and two slides synchronized by means of a synchronous gearwheel, wherein a toothing is provided on each slide for engagement with the synchronous gearwheel.

From EP 3 359 351 B1, a gripping or clamping device with a drive for driving the at least one main jaw and with a control unit is known, wherein the control unit comprises a controller for generating control signals which actuate the drive, a memory in which commands and characteristic variables are stored, and a communications interface for receiving predefinable gripping parameters.

### SUMMARY

The object to be achieved by the present invention is to provide a gripping or clamping device which can be used in a variety of ways.

It is conceivable that the drive is designed as an electric drive with an electric motor, a motor controller and a gearbox or as a pneumatic drive. Preferably, the gripping or clamping device comprises a housing in which the control unit is arranged. It is conceivable that the drive is also arranged in the housing. It is also conceivable that characteristic variables are derived from characteristic maps or that configuration data is stored in the memory during production of the gripper or the control unit and/or that parameterization takes place. Preferably, the communications interface can also send data.

The control unit is configured in such a way that commands for at least two different operating modes for operating the gripping or clamping device are stored in the memory, which commands, when they are processed by the controller, cause the controller to generate control signals for the corresponding operating mode, wherein the selection of the operating modes for which the control signals are generated is made depending on at least one predefinable gripping parameter and on at least one characteristic variable stored in the memory.

This has the advantage that the way in which the gripping or clamping device grips or clamps an item is not directly dependent on many parameters, but is determined by the control unit based on the transmitted gripping parameters. This would allow, for example, the same gripping or clamping devices to be used for different gripping tasks or for the gripping or clamping devices to carry out different gripping tasks one after the other without the need to convert the gripper. A further advantage is that the gripping parameters can be reduced to a minimum of data, and thereby reducing the load on the communications interface and/or a communications network in a machine in which the gripping or clamping device is used and accordingly simplifying the entire machine. Furthermore, implementation of a gripping or clamping device according to the invention is also simplified since the complexity of the gripping parameters to be transferred can be significantly reduced. The characteristic variables stored in the memory can also be used by the control unit to check whether the gripping or clamping device is capable of carrying out a gripping or clamping process based on the predefined gripping parameters, which leads to the protection of the gripping or clamping device and the item to be gripped.

The control unit can be configured in such a way that the controller first undertakes a selection of the operating mode in a first stage based on the gripping parameters and, in a second stage, checks whether the gripping or clamping device is capable of carrying out such a gripping process based on the characteristic variables stored in the memory. If necessary, data concerning the gripping process is then sent via the communications interface.

It is conceivable that the predefinable gripping parameters represent a target gripping force. This means that the gripping or clamping device can grip a wide variety of different items and is versatile to use. By specifying a target gripping force, the gripping force can be adjusted specifically to the item to be gripped and thereby achieving adapted gripping without damaging or losing the item.

Furthermore, it is conceivable that the predefinable gripping parameters represent an absolute target gripping force or a relative target gripping force. A relative target gripping force is predefined in particular as a value between 0 and 150% of a normal gripping force. The normal gripping force refers to a force that represents 100% of the gripping force of the gripping or clamping device. A relative target gripping force has the advantage that, in a machine controller that communicates with the control unit via the communications interface, the data to be exchanged is simplified, and it is therefore easier for an operator to configure the gripper.

Advantageously, the control unit is further configured in such a way that, depending on the predefinable gripping parameters, a gripping speed corresponding therewith of the corresponding main jaw is calculated.

Furthermore, corresponding control signals are advantageously generated so that when the main jaw or a gripping finger arranged on the main jaw hits the workpiece, the pulse is reduced compared to a gripping process with static gripping speed. As a result, the gripping or clamping device according to the invention can also be used to grip sensitive and less sensitive items without the different grippers being necessary or the gripper having to be converted between the different gripping processes in order to implement different operating modes.

It is conceivable that the control unit is further configured in such a way that commands are stored in the memory for a first operating mode, a second operating mode and/or a third operating mode. With the first operating mode, control signals are generated that result in gripping with a gripping force less than or equal to a normal gripping force. With the second operating mode, control signals are generated that result in gripping with a gripping force greater than the normal gripping force. With the third operating mode, control signals are generated that lead to gripping with a reduced pulse. By providing different operating modes, different items can be advantageously gripped or clamped. The third operating mode includes the predefined gripping speed as a predefined gripping parameter in addition to the predefined gripping force if this is below the calculated gripping speed. By gripping more slowly, the kinetic energy in the moving components of the gripper is reduced and accordingly also the pulse when the jaw hits the item. This is in particular advantageous for brittle and/or fragile items which can be used in electronics manufacturing in particular.

It is conceivable that the gripping or clamping device has a brake unit for fixing the at least one main jaw against resiliently flexible pretensioning means, wherein one of the characteristic variables stored in the memory represents the presence of the braking unit. It is conceivable that the pretensioning means are made of at least partially resiliently flexible material such as elastomer blocks or spring elements. Furthermore, it can be provided that the control unit is further configured in such a way that commands for an operating mode are stored in the memory with which control signals are generated with which brake control signals are generated for actuating the brake unit so that gripping takes place with a gripping force greater than the normal gripping force. This operating mode can in particular be the second operating mode described above. In order to achieve a gripping force greater than 100% of the normal gripping force, the at least one main jaw is moved in such a way that the pretensioning means are also resiliently deformed due to the hitting pulse of the main jaws, wherein immediately thereafter the main jaw is fixed by means of the brake unit. The pretensioning forces of the pretensioning means accordingly act as additional gripping forces. By providing a brake unit in conjunction with the pretensioning means, the range of use can be further increased.

Advantageously, the control unit is further configured in such a way that, depending on the predefinable gripping parameters, control signals are generated which cause regripping after a first contact with the item. Regripping can be caused in or following all of the previously described operating modes. The regripping works as follows: First, the control unit generates control signals corresponding to one of the operating modes. As soon as the control unit detects a first contact of the at least one jaw with the item to be gripped-this can be done, for example, by feedback from the drive due to a current increase in the drive current for the electric motor or by position sensors via the communications interface-it again generates control signals for regripping. Afterwards, there is further feedback about contact with the item. This is advantageously repeated cyclically for a predefinable period of time. This makes it possible to ensure that the item has been gripped securely without an external machine controller being used for regripping for the period of time.

It is conceivable that the control unit is further configured in such a way that, after regripping, signals are reported back via the communications interface as to whether the workpiece was gripped or lost. This means that after the regripping period has expired, further appropriate measures can be initiated by the machine controller or an operator.

The object mentioned at the outset is also achieved by a method for operating a gripping or clamping device for gripping or clamping items, in particular for operating a gripping or clamping device according to the invention, wherein the gripping or clamping device comprises at least one and preferably two main jaws which can be moved towards one another and away from one another, a drive for driving the at least one main jaw, and a control unit for generating control signals which actuate the drive, wherein the control unit comprises a memory in which commands and characteristic variables are stored.

It is further provided that the gripping or clamping device can be operated in at least two different operating modes, wherein the corresponding operating mode is selected depending on at least one predefinable gripping parameter and on at least one characteristic variable stored in the memory.

By means of a method according to the invention, a gripping or clamping device can be used in a variety of ways by predefining only simple gripping parameters for carrying out a gripping process. This simplifies the controller of such a gripper during operation and the integration of such a gripper into a machine.

It is conceivable that the characteristic variable stored in the memory is stored in the memory during assembly and/or during parameterization of the gripping or clamping device. This allows the properties of the gripper to be easily queried by the control unit and the predefined gripping parameters to be checked for plausibility, in particular as to whether the gripping or clamping device can carry out the desired gripping process or which of the at least two operating modes is being carried out.

Advantageously, the operating modes comprise a first operating mode which leads to gripping with a gripping force of less than or equal to a normal gripping force, a second operating mode which leads to gripping with a gripping force greater than the normal gripping force, and/or a third operating mode which leads to gripping with a reduced pulse. The normal gripping force refers to a force that represents 100% of the gripping force of the gripping or clamping device. For the third operating mode, a predefined gripping speed is also taken into account, in particular if it is below the gripping speed calculated based on the predefined gripping force.

It is conceivable that, depending on the predefinable gripping parameters, control signals are generated which cause regripping after a first contact with the item. Regripping is a time-limited process in which control signals for a gripping process are generated continuously from the initiation of a gripping process until the expiration of a predefinable period of time, and feedback is generated as to whether the item has been gripped. The feedback can be provided by means of a sensor system not described in detail or, for example, can be detected and generated via a current increase during gripping in the drive controller.

This object is likewise achieved by a computer program having the features of claim 13. Accordingly, the computer program comprises commands which, when the program is executed by a control unit having a controller, a memory and a communications interface, cause the latter to carry out the method according to the invention. Furthermore, the object is achieved by a computer-readable storage medium on which the computer program according to claim 13 is stored. In addition, the object is achieved by a data carrier signal which transmits the computer program according to claim 13.

Further details and advantageous designs of the invention can be found in the following description, on the basis of which embodiments of the invention are described and explained in more detail.

### BRIEF DESCRIPTION OF THE DRAWINGS

In the drawings:

FIG. 1: shows a gripping device;

FIG. 2: shows a schematic layout of a control apparatus;

FIG. 3: shows a possibility for connecting the gripping device to a machine controller;

FIG. 4: shows a diagram of different gripping force curves of the gripping device;

FIG. 5: shows a diagram of the gripping force change on an item over time; and

FIG. 6: shows a flowchart of a method for operating the gripping device.

### DETAILED DESCRIPTION

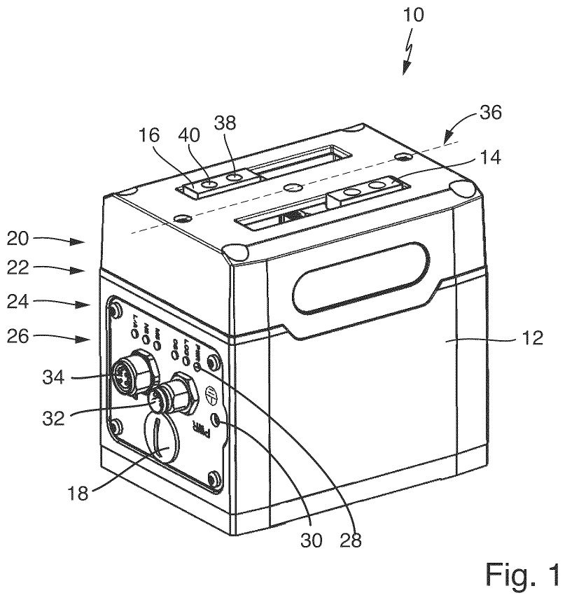

FIG. 1 shows a gripping device 10 with a housing 12, two main jaws 14, 16 which can be moved towards one another and away from one another, and a connection region 18 for a power supply and communication. A control unit 20, a drive 22, a brake unit 24 and resilient pretensioning means 26 are provided in the housing 12, wherein the braking unit 24 and the pretensioning means 26 are not provided in a further embodiment of the gripping device 10 (not shown). The connection region 18 has control lamps 28 for visualizing status messages, a ground connection 30, a connection for a power supply and data transmission 32, as well as a service interface 34.

The main jaws 14, 16 can be driven via the drive 22 and move parallel to a travel axis 36. Furthermore, gripping fingers or other accessories (not shown) can be arranged on the main jaws 14, 16 via the threads 38 and the centering holes 40.

The service interface 34 can be used in particular to transfer characteristic variables, characteristic maps and/or parameters to the gripping device 10 and to store them in a memory of the control unit 20.

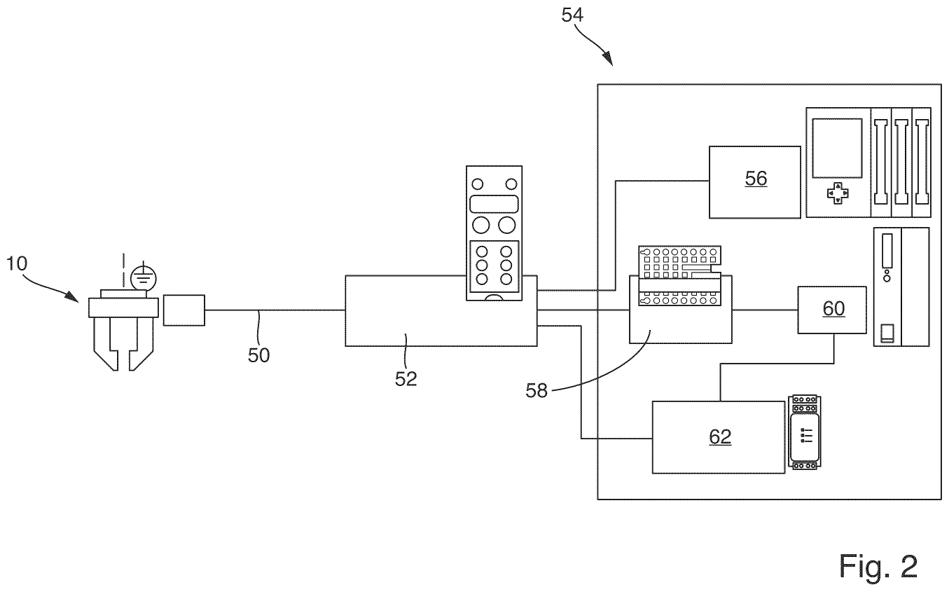

FIG. 2 shows a schematic representation in which the gripping device 10 is connected via a cable 50 and a distributor 52 to a machine controller 56 present in a control cabinet 54. In addition to the machine controllers 56, a terminal block 58, a power supply 60 and a safety switching device 62 are provided in the control cabinet 54. The control cabinet 54 can be provided for a machine in which the gripping device 10 is arranged; further machine components are conceivable but not shown.

The power supply 60 provides a voltage supply for the gripping device 10 and the safety switching device 62. The voltage in the control cabinet 54 can be distributed to other consumers such as the machine controllers 56 via the terminal block 58. The safety switching device 62 provides additional safety measures, in particular in the event of a power failure.

The distributor 52 bundles the signals of the safety switching device 62 and the machine controller 56 as well as the power supply in such a way that only the one cable 50 is required to connect the gripping device 10 to the control cabinet 54. The communication through the cable 50 between the machine controller 56 and the gripping device 10 is in particular bidirectional so that gripping parameters are predefinable by the machine controller 56 of the gripping device 10 and feedback from the gripping device 10 is also possible. In particular, position data or error messages can be reported back so that bidirectional communication takes place.

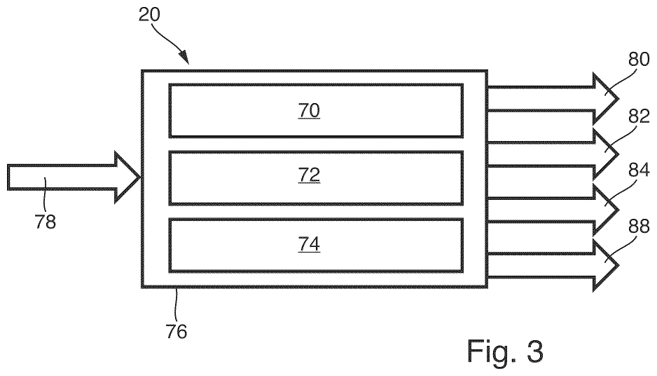

In FIG. 3, the control unit 20 with a communications interface 70, a controller 72 and a memory 74 is shown schematically in FIG. 3. The control unit 20 has a housing 76. An arrow symbolizes the signals from the machine controller 56 which contain the predefinable gripping parameters 78. The signals are transmitted to the controller 72 via the communications interface 70.

The communications interface 70 can be addressed via analog signals and/or all common digital data transmission types such as, in particular, CAN bus, Ethernet, Mod-Bus, IO-Link, I/O-BUS, Profinet and other fieldbus systems or circuit board bus systems, in particular client-server systems, wherein wireless data transmission types are also conceivable.

In the memory 74, characteristic variables 75 relating to the type and equipment of the gripping device 10 in which the control unit 20 is used are stored. The gripping parameters 78 can contain the gripping force as a relative value in percent, the gripping speed and/or the period for regripping. The characteristic variables 75 can be stored in the memory 74, in particular during assembly and/or during parameterization of the gripping or clamping device 10.

Based on the predefined gripping parameters 78 and the stored characteristic variables 75 from the memory 74, the controller 72 selects the corresponding operating mode and generates control signals from commands stored in the memory 74 for the corresponding operating mode for operating the gripping device 10. The communications interface 70 is therefore able to use at least one communications channel. The generated control signals are schematically shown by the arrows 80, 82, 84, wherein the control signals 80 are assigned to a first operating mode (BasicGrip), the control signals 82 to a second operating mode (StrongGrip) and the control signals 82 to a third operating mode (SoftGrip) or represent such an operating mode. These control signals 80, 82, 84 are passed on to the drive 22 in the gripping device 10.

Furthermore the feedback to the machine controller 56 is shown represented by the arrow 88. The feedback is also generated by the controller 72 and forwarded by the communications interface 70.

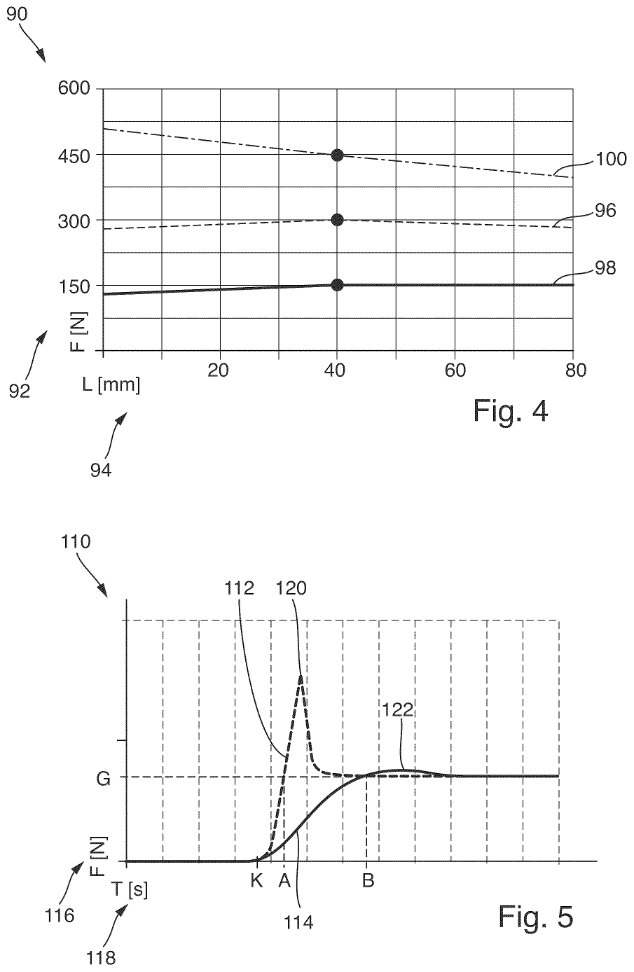

FIG. 4 shows a diagram 90 in which the gripping force 92 on the Y-axis is plotted against the length 94 of the gripping fingers that can be arranged on the main jaws 14, 16 of the gripping device 10 on the X-axis. Diagram 90 shows three gripping force curves, wherein the curve 96 and the curve 98 are assigned to the first operating mode, BasicGrip. The curve 96 represents the normal gripping force of the gripping device 10 with 100% gripping force as the relative target gripping force. The curve 98 represents 50% of the relative target gripping force. The curve 100 represents the maximum gripping force curve of the second operating mode StrongGrip with greater than 100%, here for example 150%, of the relative target gripping force. The second operating mode StrongGrip is executed when the machine controller 56 predefines a relative target gripping force of more than 100% as the gripping parameter 78. In this case, the main jaws 14, 16 are moved by the drive 22 at a maximum gripping speed so that the resiliently flexible pretensioning elements 26 are clamped when the main jaws 14, 16 hit the item and, in the pretensioned state, the controller 72 transmits control signals to the brake unit 24 via the communications interface 70 so that the main jaws 14, 16 are fixed under pretension and with increased gripping force.

FIG. 5 shows a diagram 110 in which the gripping force curve over time of two gripping processes with the different operating modes StrongGrip and SoftGrip is shown using the curves 112 and 114. The gripping force is plotted on the Y-axis 116, and the time is plotted on the X-axis 118. The curve 112 shows the gripping force curve of a gripping process corresponding to the second operating mode StrongGrip. The curve 114 shows the gripping force curve of a gripping process corresponding to the third operating mode SoftGrip. For both curves 112 and 114, the predefined gripping force G is the same and is reached in a stationary manner at time A of curve 112 and at time B of curve 114. The time K is the time of first contact of the jaws 14, 16 with the item to be gripped in both gripping processes. The slope of the curves 112, 114, i.e., the time derivative of the gripping force curve or the change in force over time, is the pulse acting on the item to be gripped. The curve 112 of the StrongGrip has a large slope and therefore a large pulse. In addition, the StrongGrip curve 112 shows a maximum 120 of the gripping force as an overshoot above the predefined target gripping force G. The SoftGrip curve 114 reaches the target gripping force G later than the StrongGrip curve 112, but has a significantly lower slope and therefore a lower pulse. The SoftGrip curve 114 or the third operating mode SoftGrip on which the curve 114 is based also has a significantly lower overshoot 122 and is therefore in particular suitable for sensitive and fragile items.

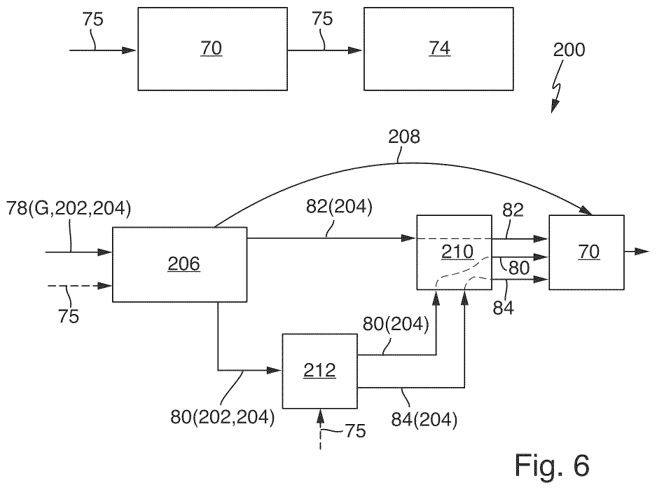

The control unit 20 is configured to carry out the method 200 shown schematically in FIG. 6. First, characteristic variables 75 are stored in the memory 74 of the control unit, in particular during assembly or parameterization of the gripping or clamping device 10. The characteristic variables 75 are received via the communications interface 70 and passed on to the memory 74 and stored there so that the controller 72 can access them during operation. A later parameterization with modified characteristic variables 75 during operation, for example during maintenance work, is conceivable.

The method 200 for selecting the operating mode is carried out during operation of the gripping or clamping device 10 using the following steps. First, the predefined gripping parameters 78, which include the target gripping force G and optionally the gripping speed 202 and a regripping parameter 204, are retrieved via the communications interface 70, and the characteristic variables 75 are retrieved from the memory 74. Based on the target gripping force G predefined by the gripping parameters 78 and the characteristic variables 75, either the first operating mode 80 (NormalGrip) or the second operating mode 82 (StrongGrip) is selected in a decision block 206 in a first stage. If no gripping speed 202 is predefined in the gripping parameters 78 and the predefined gripping force G is greater than 100%, the second operating mode (StrongGrip) is selected. If a gripping speed 202 and the predefined gripping force G is greater than 100%, no operating mode can be selected, and an error message 208 is generated which is passed to the communications interface 70. In the case where the gripping or clamping device 10 is not equipped with the components for the second operating mode (StrongGrip) and this is stored in the characteristic variables 75, an error message 208 is generated after such a plausibility check.

If a regripping parameter 204 is predefined in the gripping parameters 78, corresponding signals for regripping in the selected operating mode are generated in a block 210 and passed to the communications interface 70. If no regripping parameters 204 are predefined, the signal 80, 82, 84 is passed unchanged through the decision block 210 and sent to the communications interface 70.

In block 206, the first operating mode (NormalGrip) is initially selected if the predefined target gripping force G is equal to or below 100%. Subsequently, in a second stage in decision block 212, it is decided based on the predefined gripping speed 202 and the characteristic variables 204 as to whether the first operating mode (NormalGrip) will continue to be selected, or whether a switch will occur to the third operating mode (SoftGrip) and corresponding signals 80 or 84 will be generated. If the predefined gripping speed 202 is below a gripping speed stored in the characteristic variables 75 for the target gripping force G, the third operating mode (SoftGrip) is selected. If a regripping parameter 204 is predefined in the gripping parameters 78, then corresponding signals for regripping in the selected operating mode are generated in block 210 and passed to the communications interface 70. If no regripping parameters 204 are predefined, the signal 80, 82, 84 is passed unchanged through the decision block 210 and sent to the communications interface 70.

With the gripping device 10, different operating modes (BasicGrip StrongGrip, SoftGrip, regripping) can be provided in order to process gripping tasks with different requirements one after the other without set-up times. Furthermore, this is made possible by the fact that only a few gripping parameters 78 have to be predefined.

1-15. (canceled)

16. A gripping or clamping device for gripping or clamping items, comprising:
at least one main jaw movable towards and away from another main jaw;
a drive configured to drive the at least one main jaw; and
a control unit comprising:
a controller configured to generate control signals to actuate the drive,
a memory configured to store commands and characteristic variables, and
a communications interface configured to receive predefinable gripping parameters;
wherein the control unit is configured such that:
commands for at least two different operating modes for operating the device are stored in the memory, and
when processed by the controller, the commands cause the controller to generate control signals for the corresponding operating mode; and
wherein selection of which operating mode to operate in is based on at least one of the predefinable gripping parameters and at least one of the characteristic variables stored in the memory.

17. The gripping or clamping device of claim 16, wherein the predefinable gripping parameters represent a target gripping force.

18. The gripping or clamping device of claim 16, wherein the predefinable gripping parameters represent an absolute target gripping force.

19. The gripping or clamping device of claim 16, wherein the predefinable gripping parameters represent a relative target gripping force.

20. The gripping or clamping device of claim 16, wherein the control unit is further configured such that a gripping speed of the corresponding main jaw is calculated based on the predefinable gripping parameters.

21. The gripping or clamping device of claim 16, wherein the commands stored in the memory include:
a first operating mode in which the control signals result in gripping with a gripping force less than or equal to a normal gripping force;
a second operating mode in which the control signals result in gripping with a gripping force greater than the normal gripping force; and
a third operating mode in which the control signals result in gripping with a reduced pulse.

22. The gripping or clamping device of claim 16, further comprising:
a braking unit configured to fix the at least one main jaw against resiliently flexible pretensioning means ;
wherein one of the characteristic variables stored in the memory represents the presence of the braking unit; and
wherein the control unit is further configured such that commands are stored for an operating mode in which the control signals include brake control signals for actuating the braking unit, such that gripping takes place with a gripping force greater than the normal gripping force.

23. The gripping or clamping device of claim 16, wherein the control unit is further configured such that, based on the predefinable gripping parameters, control signals are generated to cause regripping after a first contact with the item.

24. The gripping or clamping device of claim 23, wherein the control unit is further configured to transmit a signal via the communications interface indicating whether a workpiece was gripped or lost after regripping.

25. A method for operating a gripping or clamping device comprising:
at least one main jaw movable toward and away from another jaw;
a drive configured to drive the at least one main jaw; and
a control unit configured to generate control signals to actuate the drive, the control unit including a memory in which characteristic variables are stored;
the method comprising:
operating the device in at least two different operating modes; and
selecting a corresponding operating mode based on at least one predefinable gripping parameter and at least one characteristic variable stored in the memory.

26. The method of claim 25, wherein the at least one characteristic variable stored in the memory is stored during assembly or during parameterization of the gripping or clamping device.

27. The method of claim 25, wherein the at least two different operating modes comprise:
a first operating mode for gripping with a gripping force less than or equal to a normal gripping force;
a second operating mode for gripping with a gripping force greater than the normal gripping force; and
a third operating mode for gripping with a reduced pulse.

28. The method of claim 25, further comprising generating control signals based on the predefinable gripping parameters that cause regripping after a first contact with the item.

29. A computer program comprising instructions that, when executed by a control unit having a controller, a memory, and a communications interface, cause the control unit to perform the method of claim 25.

30. A computer-readable storage medium having stored thereon the computer program of claim 29.

31. A data carrier signal configured to transmit the computer program of claim 29.
